(19) United States
(12) Patent Application Publication
(10) Pub. No.: US 2013/0276832 A1
(43) Pub. Date: Oct. 24, 2013

(54) METHOD FOR CLEANING DEPOSITS FROM A WAVE ENERGY CONVERTER

(71) Applicant: ROBERT BOSCH GMBH, Stuttgart (DE)

(72) Inventors: Lasse Langner, Ludwigsburg (DE); Nik Scharmann, Bietigheim-Bissingen (DE); Leonore Glanz, Stuttgart (DE); Juergen Hackenberg, Sachsenheim (DE); Benjamin Hagemann, Norderstedt (DE); Patrick Singer, Gaertringen (DE)

(73) Assignee: Robert Bosch GmbH, Stuttgart (DE)

(21) Appl. No.: 13/865,585

(22) Filed: Apr. 18, 2013

(30) Foreign Application Priority Data
Apr. 20, 2012 (DE) 10 2012 007 943.5

(51) Int. Cl. F03B 11/08

(52) U.S. Cl. CPC F03B 11/08
USPC 134/18; 134/34; 416/61

(57) ABSTRACT

A method for cleaning deposits from a wave energy converter includes driving at least one rotatably mounted component that is coupled to an energy converter. The energy converter is configured to convert energy from wave motion of a fluid into a different form of energy. A negative energy balance of the wave energy converter is present during the cleaning over an average period of time.

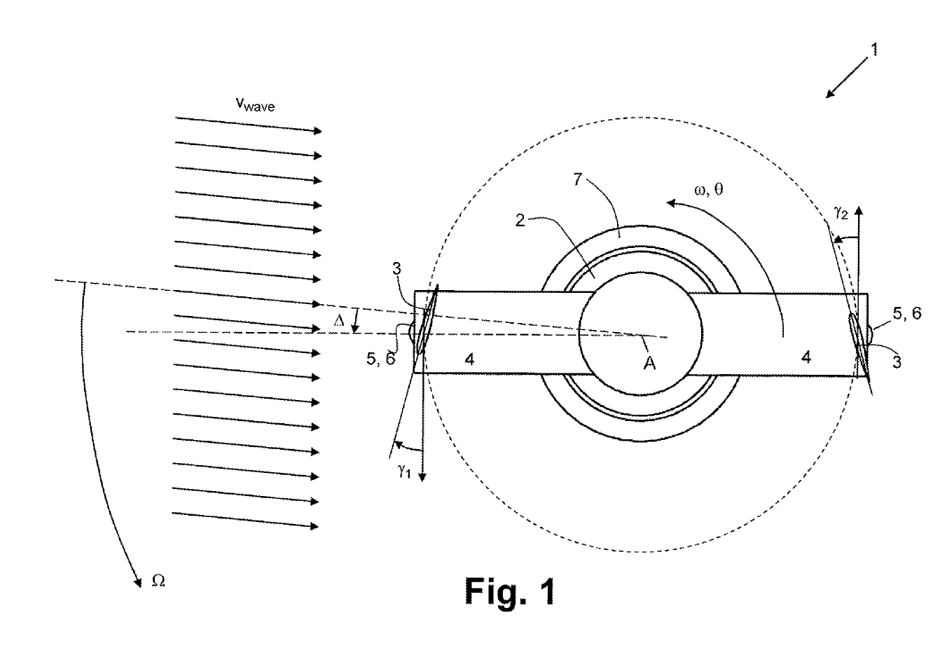

This application claims priority under 35 U.S.C. §119 to patent application no. DE 10 2012 007 943.5, filed on Apr. 20, 2012 in Germany, the disclosure of which is incorporated herein by reference in its entirety.

The present disclosure relates to a method for cleaning a wave energy converter, situated in a body of water with many waves, for converting energy from the wave motion of a fluid into a different form of energy, a computing unit for carrying it out, and a correspondingly operated wave energy converter.

### BACKGROUND

Wave power installations (wave energy converters) use the energy of waves at sea to obtain electric power. Newer configurations employ rotating units (rotors) that transform the wave motion into torque. Hydrodynamic lift bodies on these (i.e. bodies that generate lift when a fluid flows around them, such as, for example, lift profiles and/or Flettner rotors exploiting the Magnus effect) can be used as coupling bodies by means of which lift forces are generated from the wave flowing onto them and a torque, that can be converted into a rotational movement of the rotor, is generated from the arrangement of the coupling bodies on the rotor. Lift forces are created on the coupling bodies by the superposed flow onto the rotor from the orbital flow of the wave motion and the self-rotation of the rotor, as a result of which a torque is introduced into the rotor. A system configuration is known in this connection from the publication by Pinkster et al., “A rotating wing for the generation of energy from waves”, 22^{nd} International Workshop on Water Waves and Floating Bodies (IWWWFB), Plitvice, 2007, in which the lift of a lift runner onto which water flows, i.e. a coupling body generating hydrodynamic lift, is converted into rotational movement. A wave energy converter with Flettner rotors is disclosed in GB 2 226 572 A.

It has been observed that deposits (in particular biofilms, so-called biofouling) can form on installations situated in bodies of water after a short period of time. Other substances can also be deposited more easily on the biofilm. Both affect the functionality and effectiveness of a generic wave energy converter in particular because the hydrodynamic lift effect is influenced in a marked negative fashion. This results in a significantly reduced output and hence significantly higher costs for generating electricity.

The formation of biofilms can be combatted by coatings containing biocides. This is, however, subject to strict conditions or banned altogether. In particular, such coatings containing biocides are not desirable in the renewable energy industry. Deposits can also be removed by mechanical cleaning but this is time-consuming and expensive (especially on offshore installations) and interrupts the operation of the installation.

There is therefore a need for better options for cleaning deposits from a wave energy converter.

### SUMMARY

According to the disclosure, a method for cleaning a wave energy converter, a computing unit for carrying it out, and a correspondingly operated wave energy converter having the features described below are proposed. Advantageous embodiments are the subject of the following description.

The disclosure proposes an option, that is easy to implement yet effective, for cleaning a rotatably mounted component of a generic wave energy converter, in particular the rotor in this case and specifically the coupling body, or keeping it free from deposits. The component is driven by a motor and set in rotation at a certain minimum speed. The speed is adapted to the minimum flow velocity required for the cleaning and can be determined, for example, by measurement. The specified situations can be specified in particular depending on a duration during which the speed falls below a lower threshold when the wave energy converter is generating power (“normal mode”), for example when the sea is calm with little or no waves at all. The disclosure can also be implemented easily in existing installations. The component can be the rotor (for example, in order to clean the rotor including the coupling body) and/or a coupling body (in order to clean the coupling body). During the cleaning, the wave energy converter has a negative energy balance over an average period of time, i.e. more energy is required to drive the component over an average period of time than can be converted from any slight wave motion that may be present. Overall, during the cleaning the wave energy converter does not output any energy into a network, an energy store or the like, and rather it consumes it therefrom.

The disclosure is based on the finding that deposits such as, for example, biofilms can be removed independently from a structural element around which a fluid flows when the fluid flows around the structural element for a certain period of time at a certain speed of flow. For example, it has been observed that large ships such as, for example, tankers have substantially no biofilm after they have traveled a relatively short distance (just a few kilometers may suffice here) at cruising speed, when the film did not have too long beforehand to form. This is particularly true in the case where there are suitable coatings, in particular non-stick coatings, on components, such as silicone-based ones, for example.

In normal mode (energy generation or electricity generation) of a generic wave energy converter, high flow velocities occur on the coupling bodies owing to the orbital flow and the self-rotation. The velocities can be considerably more than 3 m/s, depending on the wave height and rotor configuration. At these flow velocities, a self-cleaning effect occurs in particular in combination with suitable, preferably biocide-free non-stick coatings, and any biofilms that are present are washed off. This corresponds to the observed self-cleaning effect of tankers at cruising speed. However, it is critical that there are phases with a light and/or no swell, during which there are no high and largely continuous fluid flows onto the coupling bodies. In these phases, first a biofilm forms relatively quickly and then further growth occurs on it. If these phases are sufficiently long, this growth may have already been linked to the surface of the coupling bodies sufficiently strongly that a self-cleaning effect no longer occurs even at the flow velocities that then occur during normal mode. Within the scope of the disclosure, the wave energy converter is therefore temporarily, in particular when the sea is calm, driven by a motor in order to remove deposits, in particular a biofilm that is being formed, before the latter can be used as a basis for further growth or before this further growth adheres too strongly to the coupling bodies.

The operating status of the wave energy converter is preferably monitored. The conditions of the flow onto the coupling bodies can be calculated, taking into consideration the rotor geometry, from the prevailing speed of the rotor with the coupling bodies in each case. The orbital flow itself need not be taken into account because the majority of the flow onto the coupling bodies is generated during normal mode by the rotation of the rotor and the coupling bodies. However, the orbital flow can be taken into account in order to increase accuracy. If the rotor speed and/or the flow onto the coupling bodies falls below a lower threshold value, for example because of no and/or inadequate wave motion, the rotor and/or the coupling bodies are driven by a motor in order to achieve the flow conditions required to clean off a biofilm. Alternatively, however, the status of the growth can also be monitored by a suitable sensor system, for example by optical sensors.

The duration for which the rotor and/or the coupling bodies are driven by a motor is preferably predetermined depending on the success of the cleaning. The success of the cleaning or the degree of deposits on the rotor or coupling bodies can be determined, for example, by the input power required while operating with a motor drive (in the case of Flettner rotors, thus during normal mode too). The magnitude of the input power gives information about the success of the cleaning. For example, the cleaning can be stopped when the input power drops below a certain threshold value. Alternatively, however, a predetermined cleaning program can also be run that selects suitable operating times and speeds depending on the history of the recent hours/days and other parameters such as, for example, the temperature and time of year.

The pitch of the coupling bodies is preferably set in a specified manner when the rotor and/or the coupling bodies are driven by a motor. A pitch position is preferred here in which the flow resistance is as low as possible (preferably a feathered position) in order to minimize the energy consumption required to drive the rotor and/or the coupling bodies by a motor. Forces that occur during operation are minimized as a result. More preferably, the pitch of the coupling bodies is set such that the lift forces acting on the coupling bodies compensate one another.

In an advantageous embodiment, the direction of rotation (and consequently the direction of the flow onto the coupling bodies) can be reversed intermittently in order to obtain an improved cleaning effect.

A computing unit according to the disclosure, for example a control device of a wave energy converter, is configured, in particular using a program, to carry out a method according to the disclosure.

Implementing the disclosure in the form of software is also advantageous because this enables particularly low costs, in particular when an operational computing unit is already being used for other tasks and therefore is present anyway. Suitable data supports for providing the computer program are in particular floppy disks, hard disks, flash drives, EEPROMs, CD-ROMs, DVDs, etc. It is also possible for the program to be downloaded via computer networks (Internet, Intranet, etc.).

Other advantages and embodiments of the disclosure are apparent from the description and the attached drawings.

It should be understood that the abovementioned features that will be explained below can be used not only in the respective stated combination but also in other combinations or in isolation without going beyond the scope of the present disclosure.

The disclosure is illustrated schematically in the drawings with the aid of an exemplary embodiment and is described in detail below with reference to the drawings.

### BRIEF DESCRIPTION OF THE DRAWINGS

The FIGURE shows a wave energy converter with a rotor with two coupling bodies in the form of hydrodynamic lift profiles in a side view.

### DETAILED DESCRIPTION

A wave energy converter 1 on which the present disclosure can be based, with a housing 7 as a reference point and a rotor 2, 3, 4 mounted rotatably thereon with a rotor base 2 and two coupling bodies 3 which are each fastened in nonrotatable fashion to the rotor base 2 via lever arms 4, is shown in the FIGURE. The rotor 2, 3, 4 is intended to be completely submerged just beneath the surface of a body of water with a lot of waves, for example an ocean. Deep water conditions preferably exist hereby, in which the orbital paths of the water molecules extend in a largely circular fashion. Its axis of rotation A is intended to be oriented largely horizontally and largely perpendicular to the current direction in which the waves of the body of water are propagating. In the example shown, the coupling bodies 3 take the form of hydrodynamic lift bodies. Symmetrical and non-curved profiles are shown here by way of example but the disclosure relates explicitly to all conceivable profile geometries, namely in particular to curved profiles too. Alternatively, however, other coupling bodies generating a dynamic lift, such as for example in particular Flettner rotors, can also be used. The disclosure is suitable in principle for cleaning any elements that can be moved through the water by a drive unit.

The rotating components of the wave energy converter are preferably provided with a largely neutral buoyancy in order to prevent a preferred position. This applies in particular to components of the rotor that are unsymmetrical with respect to the axis of rotation and do not have a symmetrically arranged “partner part”.

The coupling bodies 3 are arranged at an angle of approximately 180° to each other. The coupling bodies are preferably mounted in the vicinity of their center of pressure in order to reduce rotational torque that occurs on the coupling bodies during operation and hence the requirements concerning the mounting and/or the adjusting devices.

The radial spacing between the suspension point of a coupling body and the rotor axis is 1 m to 50 m, preferably 2 m to 40 m, particularly preferably 4 m to 30 m, and most particularly preferably 5 m to 20 m.

Also shown are two adjustment devices 5 for adjusting the angles of attack γ₁ and γ₂ of the coupling bodies 3 between the blade chord and tangent. The two angles of attack γ₁ and γ₂ are preferably oriented in opposite directions and preferably have values of −20° to +20°. However, larger angles of attack can also be provided, in particular when the machine is starting up. The angles of attack γ₁ and γ₂ can preferably be adjusted independently of each other. The adjustment devices can, for example, be electromotive adjustment devices—preferably with stepping motors—and/or hydraulic and/or pneumatic components.

The two adjustment devices 5 can additionally each be associated with a sensor system 6 for determining the existing angles of attack γ₁ and γ₂. A further sensor system (not shown) can determine the angle of rotation of the rotor base 2 relative to the housing 7.

The housing 7 of the wave energy converter is preferably anchored to the sea bed with the aid of suitable aids (a mooring).

The orbital current flows onto the wave energy converter 1 at a flow velocity v_{wave}. The flow is the orbital current of sea waves with a direction that is constantly changing. In the case shown, the orbital current turns counterclockwise and the associated wave thus propagates from right to left. In the case of monochromatic waves, the flow direction thus changes with the angular velocity Ω=2πf=const., where f represents the frequency of the monochromatic wave. In contrast, in polychromatic waves Ω is subject to a time change, Ω=f(t), as the frequency f is a function of time, f=f(t).

In normal mode, in order to generate electricity, the rotor 2, 3, 4 preferably rotates synchronously with the orbital current of the movement of the waves at an angular velocity ω, the term synchronicity being understood as an average over time. Hereby, Ω is for example≈ω. A value or a range of values for an angular velocity to of the rotor is thus predefined on the basis of an angular velocity Ω of the orbital current or is adapted to the latter. Constant control or a temporary or short-term adaptation can result hereby. In generating mode, the angles of attack of the two coupling bodies are preferably configured to be the opposite way round to that shown. The coupling body on the left in the FIGURE would then be shifted inwards and the coupling body on the right in the FIGURE shifted outwards. It is preferably provided here that the housing 7 is the stator of a directly driven electric machine as an energy converter, and the rotor base 2 is the runner of this directly driven electric machine, the mounting, windings etc. of which are not shown. However, other drive train variants are also possible, in particular with the inclusion of a gearbox.

Within the scope of the disclosure, the wave energy converter 1 is operated by a motor in order to clean it, a certain rotational velocity being set for a certain duration. The motor-drive operation can be effected by a corresponding current applied to the electric machine 2, 7. The current can be taken from a battery provided for this purpose, or alternatively the current can also be taken from the electricity grid via the grid connection of the wave energy power installation. The rotational velocity is preferably set in such a way that the tangential velocity of the coupling bodies is at least 3 m/s, more preferably at least 5 m/s. The duration can be fixed or be monitored online, in particular with reference to the cleaning success. The duration can, for example, be chosen so that the elements to be cleaned, for example the coupling bodies, cover a predetermined distance, for example 10 km. If the rotor 2, 3, 4 has, for example, a diameter of 20 m, approximately 170 revolutions correspond to a distance covered of 10 km. A speed of approximately ⅕s⁻¹ thus gives an operating duration of approximately 15 min, in order to achieve an adequate cleaning success.

The motor-drive operation is preferably started when the rotational velocity of the rotor 2, 3, 4 falls below a lower speed threshold (or the tangential velocity of the elements to be cleaned falls below a lower tangential velocity threshold, for example 3m/s) for longer than a predetermined duration, for example 12 h, and/or when a growth that is developing is detected by a suitable other sensor system, and/or when, in test mode, altered power values for driving the rotor are established for preset pitch parameters that are indicative of a growth. To this end, the operating status of the wave energy converter 1 is preferably monitored. During the cleaning, there is a negative energy balance of the wave energy converter over an average period of time, i.e. the energy that is required for the driving is greater than the energy that can be taken from any slight wave motion that may be present.

In the case of Flettner rotors as shown, for example, in GB 2 226 572 A, alternatively or in addition to driving the whole rotor (where the lever arms can also be cleaned), it would also be possible to drive the coupling bodies that are configured, for example, as cylinders. In the case of Flettner rotors, the coupling bodies can be driven and can be set in rotation. A sufficient orbital motion then sets a rotor carrying the coupling bodies in rotation. The surface velocity at the coupling bodies is determined from the self-rotation, the rotation of the rotor, and the flow around them. The motor-drive operation for cleaning purposes is preferably started when the surface velocity at the coupling bodies falls below a lower tangential velocity threshold, for example 3 or 5 m/s, for longer than a predetermined duration, for example 12 h, and/or when a growth that is developing is detected by a suitable other sensor system. During the cleaning, there is a negative energy balance of the wave energy converter over an average period of time, i.e. the energy that is required for the driving is greater than the energy that can be taken from any slight wave motion that may be present.

What is claimed is:

1. A method for cleaning deposits from a wave energy converter, comprising:
driving at least one rotatably mounted component that is coupled to an energy converter,
wherein the energy converter is configured to convert energy from wave motion of a fluid into a different form of energy, and
wherein a negative energy balance of the wave energy converter is present during the cleaning over an average period of time.

2. The method according to claim 1, further comprising:
setting a rotatably mounted rotor in rotation by the wave motion to drive the energy converter.

3. The method according to claim 2, wherein the at least one rotatably mounted component is the rotor.

4. The method according to claim 3, further comprising:
adjusting a pitch of at least one coupling body of the rotor such that a flow resistance on the at least one coupling body has a predetermined value.

5. The method according to claim 3, further comprising:
separately adjusting a pitch of at least two coupling bodies of the rotor such that forces acting on the at least two coupling bodies compensate one another.

6. The method according to claim 2, wherein the at least one rotatably mounted component is a coupling body that is mounted rotatably on the rotor and/or is driven separately.

7. The method according to claim 1, wherein driving at least one rotatably mounted component includes driving the at least one rotatably mounted component such that rotation of the at least one rotatably mounted component exceeds a predeterminable minimum speed.

8. The method according to claim 1, wherein driving at least one rotatably mounted component includes driving the at least one rotatably mounted component such that a predeterminable flow velocity on a surface of the component is exceeded.

9. The method according to claim 1, wherein driving at least one rotatably mounted component includes driving the at least one rotatably mounted component when a rotation of the component, caused by the wave motion, falls below a lower speed threshold for longer than a predeterminable duration.

10. The method according to claim 1, wherein driving at least one rotatably mounted component includes driving the at least one rotatably mounted component when a flow velocity on a surface of the component falls below a lower flow velocity threshold for longer than a predeterminable duration.

11. The method according to claim 1, further comprising:
determining at least one of a cleaning time and cleaning success with a sensor system.

12. The method according to claim 1, wherein driving at least one rotatably mounted component includes driving the at least one rotatably mounted component with one of the energy converter and a separate drive unit.

13. The method according to claim 1, further comprising:
determining at least one of a cleaning time and a cleaning success using power consumption required to drive the at least one rotatably mounted component.

14. The method according to claim 1, wherein driving at least one rotatably mounted component includes driving the at least one rotatably mounted component for a duration that is determined as a function of at least one of the cleaning success and a distance to be covered of a reference point of the component.

15. The method according to claim 1, wherein, during the cleaning, a direction of rotation of the at least one rotatably mounted component is altered and/or the direction of rotation of the at least one rotatably mounted component during the cleaning is at least temporarily opposite to a direction of rotation of the at least one rotatably mounted component in a normal mode.

16. A computing unit configured to carry out a method for cleaning deposits from a wave energy converter, comprising:
a device configured to drive at least one rotatably mounted component that is coupled to an energy converter,
wherein the energy converter is configured to convert energy from wave motion of a fluid into a different form of energy, and
wherein a negative energy balance of the wave energy converter is present during the cleaning over an average period of time

17. A wave energy converter comprising:
at least one rotatably mounted component;
an energy converter coupled to the at least one rotatably mounted component and configured to convert energy from wave motion of a fluid into a different form of energy; and
a computing unit including a device configured to drive the at least one rotatably mounted component.

18. The wave energy converter according to claim 17, wherein the at least one rotatably mounted component is coated at least partially with a non-stick coating.

19. The wave energy converter according to claim 17, further comprising:
at least one rotatably mounted rotor that has at least one coupling body configured to generate a torque on the at least one rotatably mounted rotor by generating a hydrodynamic lift force.
